(19) United States
(12) Patent Application Publication
(10) Pub. No.: US 2014/0359532 A1
(43) Pub. Date: Dec. 4, 2014

(54) ELECTRONIC DEVICE, DISPLAY CONTROL METHOD AND STORAGE MEDIUM

(71) Applicant: Kabushiki Kaisha Toshiba, Tokyo (JP)

(72) Inventor: Yuki KANBE, Ome-shi (JP)

(73) Assignee: Kabushiki Kaisha Toshiba, Tokyo (JP)

(21) Appl. No.: 14/252,733

(22) Filed: Apr. 14, 2014

(30) Foreign Application Priority Data
May 31, 2013 (JP) 2013-116346

(51) Int. Cl. G06F 3/0481; G06F 3/0488; G06F 3/0482

(52) U.S. Cl. CPC G06F 3/04817; G06F 3/0482; G06F 3/0488
USPC 715/835

(57) ABSTRACT

According to one embodiment, an electronic device includes a first display controller. The controller displays a list of first objects representing actions on a touch screen display. The controller displays, on the display, a list of second objects representing targets corresponding to one of the actions represented by one of the first objects when a touch operation is performed on the one first object. The controller displays, on the display, a list of third objects representing programs for executing the one action represented by the one first object on one of the targets represented by one of the second objects when a touch operation is performed on the one second object.

### CROSS-REFERENCE TO RELATED APPLICATIONS

This application is based upon and claims the benefit of priority from Japanese Patent Application No. 2013-116346, filed May 31, 2013, the entire contents of which are incorporated herein by reference.

### FIELD

Embodiments described herein relate generally to a user interface control technique suitable for, for example, a tablet terminal.

### BACKGROUND

Portable electronic devices, such as tablet terminals and smartphones, which can be powered by a battery, have become widely used. Most of electronic devices of this type include a touch screen display that facilitates input operation by a user.

By touching an icon or menu displayed on the touch screen display, using a finger or pen, the user can instruct the electronic device to execute the function associated with the icon or menu.

Regarding a user interface using such an icon or menu as the above, various proposals have been made so far.

In the above electronic devices, a list of application program names is generally displayed as a list of icons or menus. In this case, it is assumed that the user understands for what each application program is used.

However, persons at the entry level often do not understand what can be done by the electronic device, or which application program can be used (to perform a target operation). For these persons, the user interface that displays a list of application programs is not so convenient.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic device according to an embodiment.

FIG. 2 is an exemplary block diagram showing a system configuration of the electronic device of the embodiment.

FIG. 3 is an exemplary block diagram showing examples of screen shifts displayed on the touch screen display by the Home application operating on the electronic device of the embodiment.

FIG. 4 is an exemplary view showing a configuration example of an application installer for installing an application program into the electronic device of the embodiment.

FIG. 5 is an exemplary first view showing a structure example of menu structure data created and managed by a Home application operating on the electronic device of the embodiment.

FIG. 6 is an exemplary second view showing another structure example of menu structure data created and managed by the Home application operating on the electronic device of the embodiment.

FIG. 7 is an exemplary flowchart showing a first procedure of screen shift processing executed by the Home application operating on the electronic device of the embodiment.

FIG. 8 is an exemplary flowchart showing a second procedure of screen shift processing executed by the Home application operating on the electronic device of the embodiment.

### DETAILED DESCRIPTION

Various embodiments will be described hereinafter with reference to the accompanying drawings.

In general, according to one embodiment, an electronic device includes a touch screen display and a first display controller. The first display controller is configured to display a list of first objects representing actions on the touch screen display. The first display controller is further configured to display, on the touch screen display, a list of second objects representing targets corresponding to one of the actions represented by one of the first objects when a touch operation is performed on the one first object displayed on the touch screen display. The first display controller is further configured to display, on the touch screen display, a list of third objects representing programs for executing the one action represented by the one first object on one of the targets represented by one of the second objects when a touch operation is performed on the one second object displayed on the touch screen display.

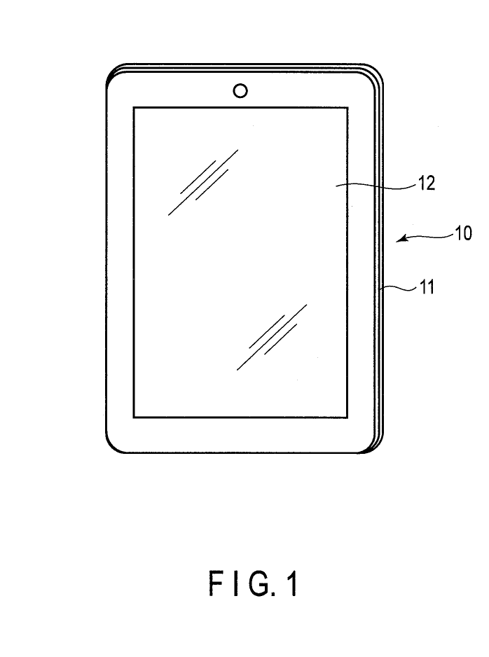

An electronic device according to the embodiment can be realized as a portable electronic device, such as a tablet terminal or a smartphone, to which data can be input by a finger touch. FIG. 1 is an exemplary perspective view showing an appearance of the electronic device of the embodiment. In the embodiment, it is assumed that the electronic device is realized as a table terminal 10 as shown in FIG. 1. The tablet terminal 10 includes a main unit 11 and a touch screen display 12. The touch screen display 12 is attached to the main unit 11, superposed on the entire upper surface of the main unit 11.

The main unit 11 includes a thin rectangular housing. The touch screen display 12 incorporates a flat panel display, and a sensor configured to detect the tough position of a finger on the flat panel display. The flat panel display is, for example, a liquid crystal display (LCD). The sensor is, for example, a touch panel of an electrostatic capacitance type. The touch panel is provided to cover the screen of the flat panel display.

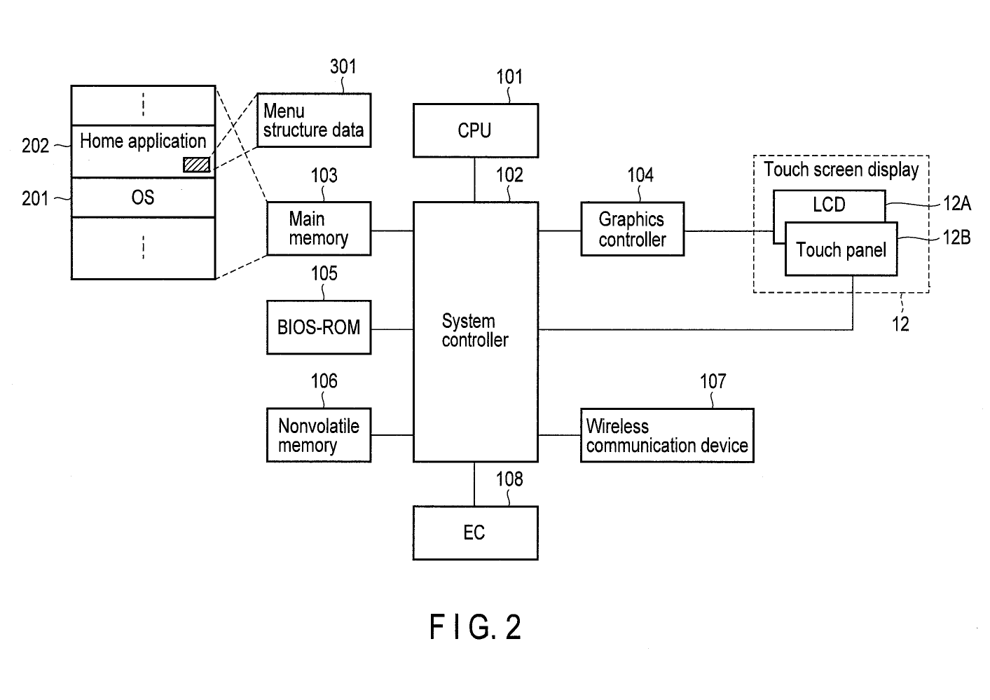

FIG. 2 is an exemplary block diagram showing a system configuration of the tablet terminal 10.

As shown in FIG. 2, the tablet terminal 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor configured to control the operation of each module in the tablet terminal 10. The CPU 101 executes various types of software loaded from the nonvolatile memory 106 to the main memory 103. These software items include an operating system (OS) 201, and a Home application 202 described later. The Home application 202 includes a function of creating and managing menu structure data 301 described later.

The CPU 101 also executes the basic input/output system (BIOS) stored in the BIOS-ROM 105. The BIOS is a program for controlling hardware.

The system controller 102 is configured to connect the local bus of the CPU 101 to various components. The system controller 102 contains a memory controller configured to control access to the main memory 103. The system controller 102 also includes a function of communicating with the graphics controller 104 via, for example, a serial bus of PCI EXPRESS standard.

The graphics controller 104 is a display controller configured to control an LCD 12A used as the display monitor of the tablet terminal 10. A display signal generated by the graphics controller 104 is sent to the LCD 12A. The LCD 12A displays a screen image corresponding to the display signal. A tough panel 12B is provided on the LCD 12A. The tough panel 12B is a pointing device of, for example, an electrostatic capacitance type, which enables inputting on the screen of the LCD 12A. The position on the screen, which is touched by a finger, is detected by the touch panel 12B.

The wireless communication device 107 is configured to perform wireless communication, such as wireless LAN or 3G mobile communication. The EC 108 is a single-chip microcomputer including an embedded controller for power management. The EC 108 includes a function of turning on/off the tablet terminal 10 in accordance with a user's operation of a power button.

A description will now be given of the Home application 202 that operates on the tablet terminal 10 with the above-described system configuration.

The Home application 202 is one of the various application programs operative under the control of the OS 201, and provides a graphical user interface (GUI) unique to the tablet terminal 10 of the embodiment. The function of the Home application 202 can be realized as one module in the OS 201.

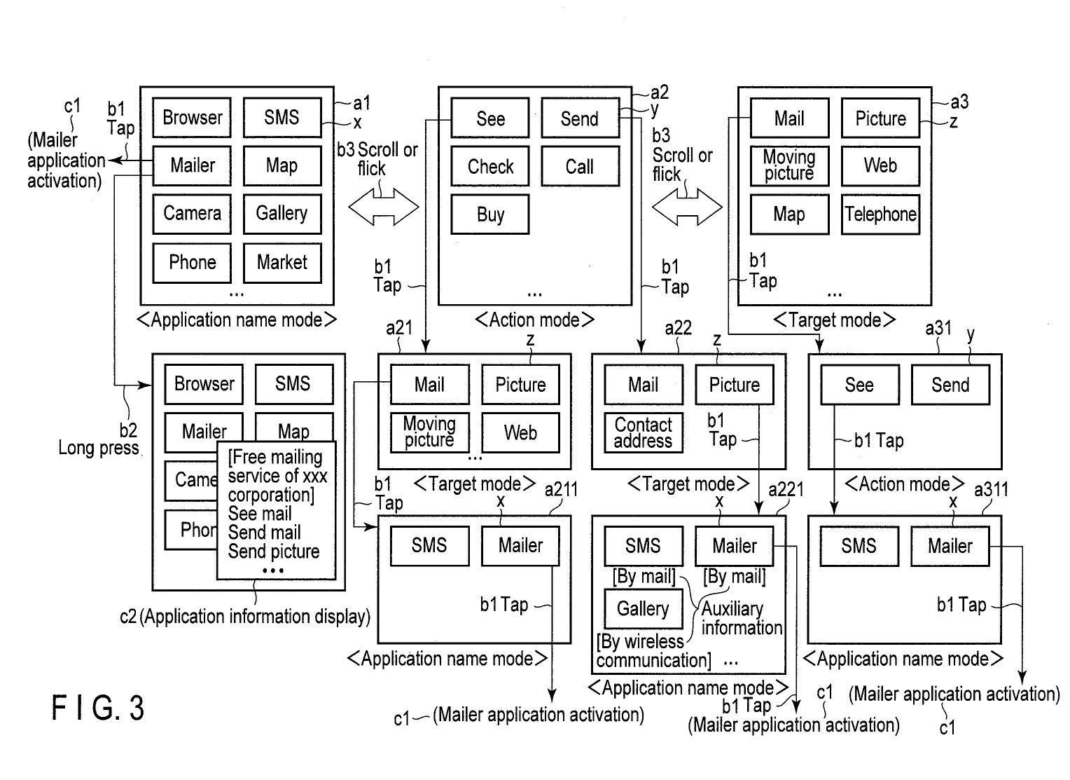

FIG. 3 is an exemplary block diagram showing examples of screen shifts displayed by the Home application 202 on the touch screen display 12.

In FIG. 3, a screen al is displayed on the GUI generally provided by, for example, a standard tablet terminal or smartphone. This screen shows a list of icons x (third objects) indicating application programs. In the embodiment, the operation mode for displaying the list of icons x indicating the application programs is referred to as an application name mode. For instance, when the tablet terminal 10 is turned on, the Home application 202 displays a list of icons x indicating application programs in the application name mode.

The user, who understands for what each application program is used, can activate a target application program by touching, on the screen, the icon x corresponding to the target application program, as in the standard tablet terminal or smartphone. The tough operation of each icon x for activating the corresponding application program is, for example, a touch operation (b1) called, for example, a tap realized by a touch on the touch screen display 12 for a period less than a threshold.

Specifically, “Mailer” in FIG. 3 is an application program for transmitting and receiving emails, and the user who wants to perform transmission and reception of emails executes a touch operation (b1) on the icon x corresponding to “Mailer”. After the touch operation (b1) is thus performed on this icon x, the Home application 202 executes processing (c1) for requesting the OS 201 to activate the application program represented by this icon x.

Further, after a touch operation (b2) called, for example, a long press realized by a touch on the touch screen display 12 for a period more than the threshold is performed on a certain icon x, the Home application 202 executes processing (c2) for displaying information concerning the application program represented by the certain icon x. The user interface function of displaying information concerning the application program is unique to the Home application 202 that operates on the tablet terminal 10 of the embodiment. The principle of this process will be described later.

Screens a2 and a3 in FIG. 3 are unique to the GUI provided by the Home application 202. The screen a2 displays a list of icons y (first objects) that represent actions performed utilizing corresponding application programs. The screen a3 displays a list of icons z (second objects) that represent targets (of the operations performed utilizing corresponding application programs). In the embodiment, the operation mode for displaying the list of icons y representing actions will hereinafter be referred to as “an action mode”, and the operation mode for displaying the list of icons z representing targets will hereinafter be referred to as “a target mode”. Note that the “action mode” and the “target mode” are merely examples, and may be changed to, for example, a “verb mode” and an “object mode”, respectively.

The Home application 202 performs switching between the screens a1, a2 and a3 when, for example, a touch operation (b3) called a scroll or flick, for sliding a finger on the touch screen display 12 has been performed.

Assume here that the user wants to confirm newly arrived email, but that they do not know which application program should be used for this purpose. Namely, assume that they do not figure out that “Mailer” should be selected from the icons x listed on the screen a1.

The Home application 202 operating on the tablet terminal 10 of the embodiment provides a GUI that enables even such a user as the above to select “Mailer”. Firstly, a description will be given of an example of a screen shift beginning with the screen a2.

As mentioned above, the screen a2 displays a list of icons y representing actions. The user, who wants to confirm “newly arrived email”, selects “see” from the icons y listed on the screen a2, which substantially corresponds to the action they want to take, and performs a touch operation (b1) on this icon y. After the touch operation (b1) is performed on this icon y, the Home application 202 displays a list of icons z representing targets that can be regarded as a target of the action represented by the above icon y. In this example, since the icon y corresponding to “see” has been selected on the screen a2, the screen is shifted to a screen a21 that displays a list of icons z representing targets, such as “mail”, “picture”, “moving picture”, “Web”, etc.

After shifting to the screen a21, the user, “who wants to confirm newly arrived email”, selects “mail” coinciding with the target of action they want to take, from the icons z listed on the screen a21, and performs a touch operation (b1) on the icon z. After the touch operation (b1) is performed on this icon z, the Home application 202 displays a list of icons x representing the application programs that can be executed for the action represented by the icon y selected on the screen a2 and that can be executed on the target represented by the icon z selected on the screen a21. In this case, since the icon z indicating “mail” has been selected on the screen a21, the screen is shifted to a screen a211 displaying a list of application programs, such as short message service (SMS), “Mailer”, etc.

As described above, stepwise restriction is performed in the order of “action” (action mode)→“target” (target mode)→“application program” (application name mode), while sequentially displaying the list of icons y, the list of icons z and the list of icons x. Thus, the Home application 202 operating on the tablet terminal 10 of the embodiment leads, to an appropriate application program, the user who does not know well what application program should be used for attaining the purpose.

Further, after the touch operation (b1) is performed on a certain icon x on the screen a211, the Home application 202 executes processing (c1) for requesting the OS 201 to activate the application program corresponding to this icon x.

A description will now be given of an example of a screen shift beginning with the screen a3.

As mentioned above, the screen a3 displays a list of icons z representing targets. The user, “who wants to confirm newly arrived email”, selects “mail” coinciding with the target of the action they want to take, from the icons z listed on the screen a3, and performs a touch operation (b1) on the selected icon z. After the touch operation (b1) is performed on the selected icon z, the Home application 202 displays a list of icons y representing the actions that can be taken for the target represented by the selected icon z. In this example, since the icon z corresponding to “mail” has been selected on the screen a3, the screen a3 is shifted to a screen a31 that displays a list of icons z representing actions, such as “see” and “send”.

After shifting to the screen a31, the user, “who wants to confirm newly arrived email”, selects “see” substantially coinciding with the action they want to take, from the icons y listed on the screen a31, and performs a touch operation (b1) on the selected icon y. After the touch operation (b1) is performed on the selected icon y, the Home application 202 displays a list of icons x representing the application programs that can be executed on the target represented by the icon z selected on the screen a3 and that can be executed for the action represented by the icon y selected on the screen a31. In this example, since the icon y corresponding to “see” has been selected on the screen a31, the screen a31 is shifted to a screen a311 that displays a list of icons x representing application programs, such as “SMS” and “Mailer”.

As described above, stepwise restriction is performed in the order of “target” (target mode)→“action” (action mode)→“application program” (application name mode), while sequentially displaying the lists of icons y, icons z and icons x. Thus, the Home application 202 operating on the tablet terminal 10 of the embodiment leads, to an appropriate application program, the user who does not know well what application program should be used for attaining the purpose.

Further, after a touch operation (b1) is performed on a certain icon x on the screen a311, the Home application 202 executes processing (c1) for requesting the OS 201 to activate the application program represented by this icon x.

A description will be given of the principle on which the Home application 202 performs the screen shifts shown in FIG. 3.

As aforementioned, the Home application 202 includes a function of creating and managing the menu structure data 301. Using the menu structure data 301, the Home application 202 executes screen shift processing shown in FIG. 3. Creation of the menu structure data 301 will be described firstly.

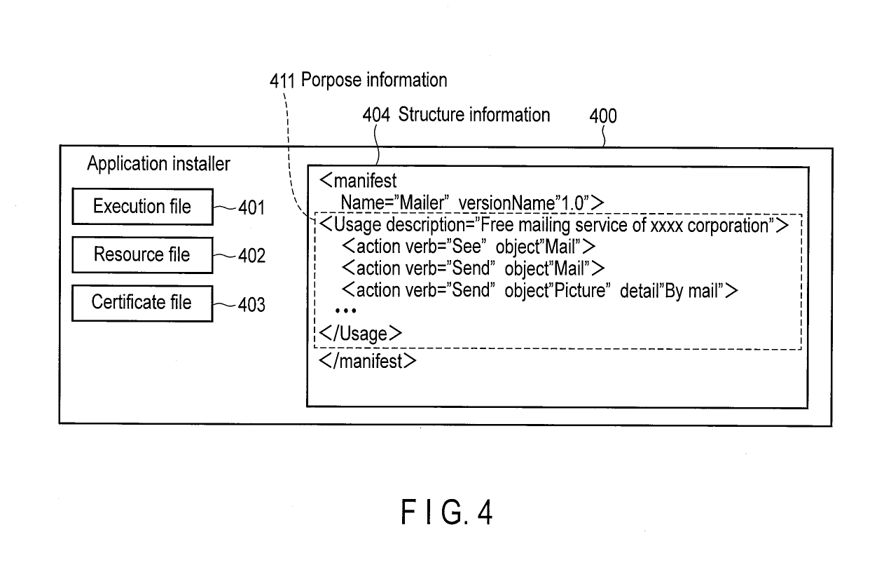

Various application programs can be installed in the table terminal 10. FIG. 4 is an exemplary view showing a configuration example of an application installer 400 downloaded from, for example, a website on the Internet.

As shown in FIG. 4, the application installer 400 includes an execution file 401, a resource file 402, a certificate file 403 and structure information 404. The structure information 404 includes purpose information 411. The Home application 202 creates the menu structure data 301 using the structure information 404 including the purpose information 411.

From the structure information 404 of the application installer 400, firstly, its application program name (“Mailer”) can be acquired, and secondly, at least one combination of an action that can be taken by the application program and the target of the action can be acquired using the purpose information 411. Yet further auxiliary information can be acquired depending upon how information items are combined.

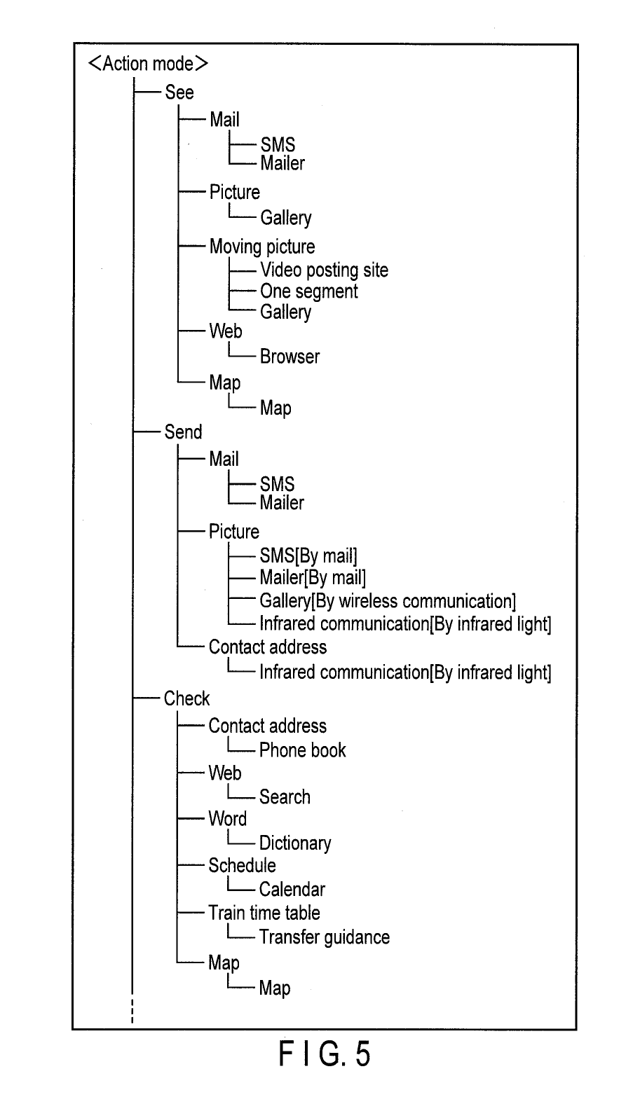

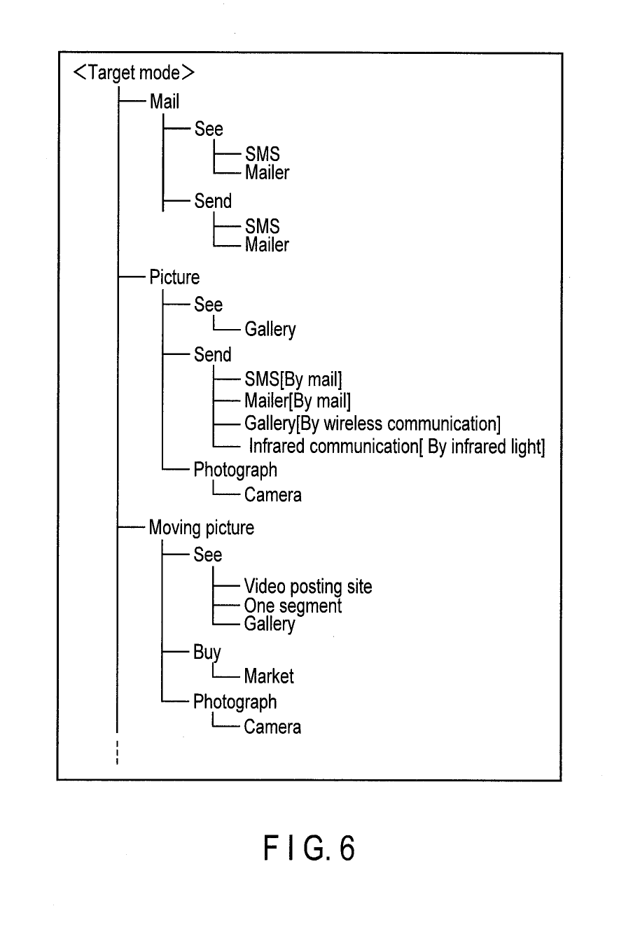

From the structure information 404, the Home application 202 detects that “Mailer” is associated with the purposes of, for example, “seeing mail”, “sending mail”, and “sending a picture”, and creates, as the menu structure data 301, two types of hierarchical structure lists as shown in FIG. 5 and FIG. 6.

FIG. 5 shows a hierarchical structure list for a screen shift beginning with the screen a2.

Based on the structure information 404 contained in the application installer 400 for each application program, the Home application 202 creates a hierarchical structure list in the order of “action”→“target”→“application name”. As aforementioned, auxiliary information can be acquired depending upon the combination of an action and its target. This auxiliary information is stored as additional information of “application name” in the hierarchical structure list.

Referring to the hierarchical structure list (menu structure data 301), the Home application 202 executes processing of (a) presenting the screen a2 that displays a list of icons y representing actions, such as “see”, “send” and “check”, (b) presenting the screen a21 that displays a list of icons z representing targets, such as “mail”, “picture”, “moving picture” and “web”, if the icon y “see” has been selected on the screen a2, and (c) presenting the screen a211 that displays a list of icons x representing application programs, such as “SMS” and “Mailer”, if the icon z “mail” has been selected on the screen a21.

FIG. 6 shows a hierarchical structure list for a screen shift beginning with the screen a3.

Based on the structure information 404 contained in the application installer 400 for each application program, the Home application 202 creates a hierarchical structure list in the order of “target”→“action”→“application name”. Auxiliary information is also added in the hierarchical structure list.

Referring to the hierarchical structure list (menu structure data 301), the Home application 202 executes processing of (a) presenting the screen a3 that displays a list of icons z representing targets, such as “mail”, “picture” and “moving picture”, (b) presenting the screen a31 that displays a list of icons y representing actions, such as “see” and “send”, if the icon z “mail” has been selected on the screen a3, and (c) presenting the screen a211 that displays a list of application programs, such as “SMS” and “Mailer”, if the icon y “see” has been selected on the screen a31.

Thus, the Home application 202 creates the menu structure data 301 from the structure information 404 of the application installer 400, and executes screen shift processing shown in FIG. 3, using the menu structure data 301.

In standard tablet terminals and smartphones, when, for example, a new application program is installed, users generally perform such an operation as adjustment in the arrangement of an icon representing the installed program, in consideration of the category thereof. However, the tablet terminal 10 of the embodiment does not require this operation, because the Home application 202 automatically sets up the screen.

Now return to FIG. 3.

If the icon y “send” has been selected on the screen a2 in FIG. 3, the screen is shifted to a screen a22 that displays a list of icons z representing targets, such as “mail”, “picture” and “contact address”, in accordance with the hierarchical structure list shown in FIG. 5. If the icon z “picture” has been selected on the screen a22, the screen is shifted to a screen a221 that displays a list of icons x representing application programs, such as “SMS”, “Mailer” and “Gallery”, in accordance with the hierarchical structure list shown in FIG. 5. At this time, if auxiliary information is stored as additional information of “application name” in the hierarchical structure list, the Home application 202 displays this auxiliary information along with the icon x.

This induces the user to select “SMS” or “Mailer” if they want to send a picture by mail, or to select “Gallery” if they want to send a picture by wireless communication such as Bluetooth (registered trademark).

Further, as described above, after a touch operation (b2) called, for example, a long press is performed on an icon x, the Home application 202 performs processing (c2) for displaying information corresponding to the application program represented by this icon x. For instance, if a touch operation (b2) has been performed on the icon x “Mailer”, the Home application 202 refers to the structure information 404 contained in the application installer 400 for “Mailer”, thereby displaying information concerning “Mailer”, using the purpose information 411 contained in the structure information 404.

Thus, the user can confirm information associated with application programs at any time.

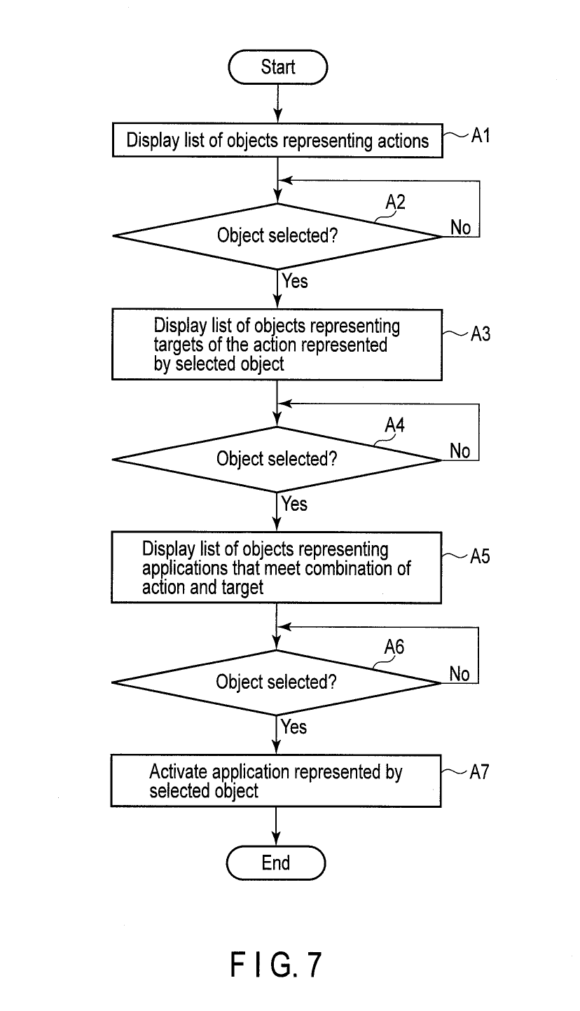

FIG. 7 is an exemplary flowchart showing a first procedure (a screen shift beginning with the screen a2) of screen shift processing executed by the Home application 202.

Firstly, the Home application 202 displays a list of icons y representing actions (block A1). If one of the icons y has been selected (Yes in block A2), the Home application 202 displays a list of icons z representing the targets of the actions represented by the icons y (block A3).

If one of the icons z has been selected (Yes in block A4), the Home application 202 displays a list of icons x representing the application programs that meet the combination of the action represented by the selected icon y and the target represented by the selected icon z (block A5).

If one of the icons x has been selected (Yes in block A6), the Home application 202 requests the OS 201 to activate the application program represented by the selected icon x (block A7).

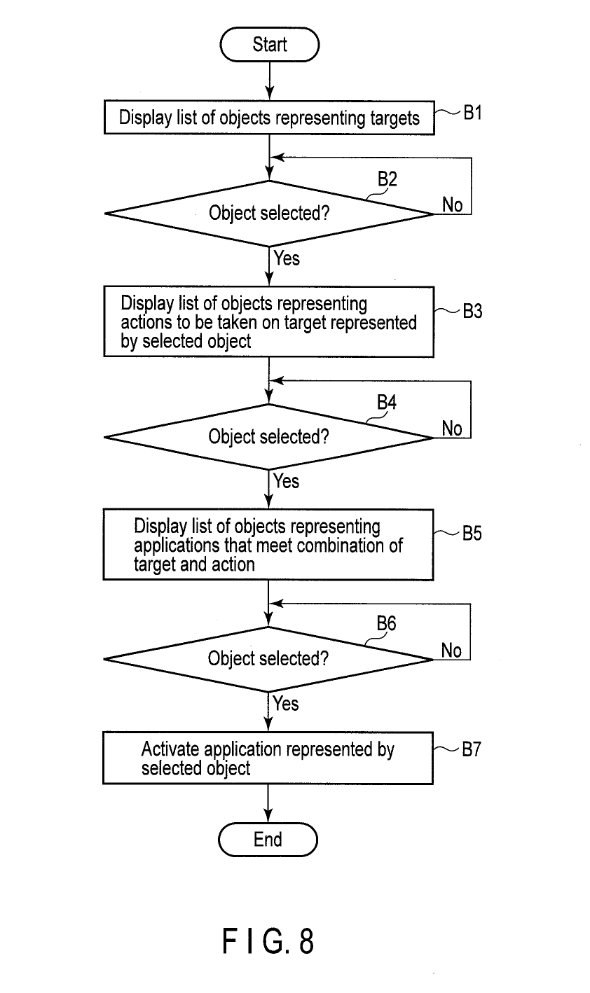

FIG. 8 is an exemplary flowchart showing a second procedure (a screen shift beginning with the screen a3) of screen shift processing executed by the Home application 202.

Firstly, the Home application 202 displays a list of icons z representing targets (block B1). If one of the icons z has been selected (Yes in block B2), the Home application 202 displays a list of icons y representing the actions to be performed on the targets represented by the icons z (block B3).

If one of the icons y has been selected (Yes in block B4), the Home application 202 displays a list of icons x representing the application programs that meet the combination of the target represented by the selected icon z and the action represented by the selected icon y (block B5).

If one of the icons x has been selected (Yes in block B6), the Home application 202 requests the OS 201 to activate the application program represented by the selected icon x (block B7).

As described above, the tablet terminal 10 of the embodiment provides a user interface convenient to even persons at the entry level.

It is possible that only one application program is finally presented to users as a result of stepwise restriction of “action”→“target”→“application program”, or of “target”→“action”→“application program”. In this case, only one icon x representing the application program may be displayed. Alternatively, display of the icons x may be omitted, and a request may be made of the OS 201 to activate the application program. Further, a user interface for setting whether the application program is automatically activated without user's touch operation (b1) on the icon x in this case may be installed in the Home application 202.

The Home application 202 may create and store the managing menu structure data 301 in the nonvolatile memory 106, and load the same onto the main memory 103 when the tablet terminal 10 is activated. Alternatively, each time the tablet terminal 10 is activated, the Home application 202 may create the managing menu structure data 301 onto the main memory 103, referring to the structure information 404 contained in each installer 400 in the nonvolatile memory 106, and load the same onto the main memory 103.

Since the operation procedure of the embodiment can be realized by software (program), the same advantage as that of the embodiment can be easily obtained simply by installing the software in a standard computer through a computer-readable storage medium storing the software.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a touch screen display; and
a first display controller configured
to display a list of first objects representing actions on the touch screen display,
to display, on the touch screen display, a list of second objects representing targets corresponding to one of the actions represented by one of the first objects when a touch operation is performed on the one first object displayed on the touch screen display, and
to display, on the touch screen display, a list of third objects representing programs for executing the one action represented by the one first object on one of the targets represented by one of the second objects when a touch operation is performed on the one second object displayed on the touch screen display.

2. The device of claim 1, further comprising a program activation controller configured to activate, in a case that only one third object is to be displayed on the touch screen display by the first display controller, a program represented by said third object.

3. The device of claim 2, wherein the first display controller is configured to suppress display of said third object on the touch screen display in the case that only one third object is to be displayed on the touch screen display.

4. The device of claim 2, further comprising a setting controller configured to set whether to activate a program represented by said third object, in the case that only one third object is to be displayed on the touch screen display.

5. The device of claim 4, wherein the first display controller is configured to suppress display of said third object on the touch screen display, in the case that only one third object is to be displayed on the touch screen display and when the setting controller sets that the program represented by said third object is to be activated by the program activation controller.

6. The device of claim 1, further comprising:
a program activation controller configured to activate a program represented by a third object when a first touch operation is performed on the third object displayed on the touch screen display; and
a detailed information display controller configured to display detailed information concerning the program represented by the third object when a second touch operation is performed on the third object displayed on the touch screen display.

7. The device of claim 6, wherein:
the first touch operation comprises a touch operation in which the touch screen display is touched for a period shorter than a threshold value; and
the second touch operation comprises a touch operation in which the touch screen display is touched for a period equal to or longer than the threshold value.

8. The device of claim 1, further comprising a second display controller configured
to display the list of the second objects representing the targets of the actions on the touch screen display,
to display, on the touch screen display, the list of the first objects representing the actions to be performed on one of the targets represented by one of the second objects when a touch operation is performed on the one second object displayed on the touch screen display, and
to display, on the touch screen display, the list of the third objects representing the programs for executing one of the actions represented by one of the first objects on the one target represented by the one second object when a touch operation is performed on the one first object displayed on the touch screen display.

9. The device of claim 8, further comprising a program activation controller configured to activate, in a case that only one third object is to be displayed on the touch screen display by the first or second display controller, a program represented by said third object.

10. The device of claim 9, wherein the first and second display controller are configured to suppress display of said third object on the touch screen display in the case that only one third object is to be displayed on the touch screen display.

11. The device of claim 9, further comprising a setting controller configured to set whether to activate a program represented by said third object, in the case that only one third object is to be displayed on the touch screen display by the first or second display controller.

12. The device of claim 11, wherein the first and second display controller are configured to suppress display of said third object on the touch screen display, in the case that only one third object is to be displayed on the touch screen display and when the setting controller sets that the program represented by said third object is to be activated by the program activation controller.

13. The device of claim 8, further comprising:
a program activation controller configured to activate a program represented by a third object when a first touch operation is performed on the one third object on the touch screen display; and
a detailed information display controller configured to display detailed information concerning the program represented by the third object when a second touch operation is performed on the third object displayed on the touch screen display.

14. The electronic device of claim 13, wherein:
the first touch operation comprises a touch operation in which the touch screen display is touched for a period shorter than a threshold value; and
the second touch operation comprises a touch operation in which the touch screen display is touched for a period equal to or longer than the threshold value.

15. A display control method for an electronic device, the method comprising:
displaying a list of first objects representing actions on a touch screen display, displaying, on the touch screen display, a list of second objects representing targets corresponding to one of the actions represented by one of the first objects when a touch operation is performed on the one first object displayed on the touch screen display, and displaying, on the touch screen display, a list of third objects representing programs for executing the one action represented by the one first object on one of the targets represented by one of the second objects when a touch operation is performed on the one second object displayed on the touch screen display; and
displaying the list of the second objects representing the targets of the actions on the touch screen display, displaying, on the touch screen display, the list of the first objects representing the actions to be performed on one of the targets represented by one of the second objects when a touch operation is performed on the one second object displayed on the touch screen display, and displaying, on the touch screen display, the list of the third objects representing the programs for executing one of the actions represented by one of the first objects on the one target represented by the one second object when a touch operation is performed on the one first object displayed on the touch screen display.

16. A computer-readable, non-transitory storage medium having stored thereon a computer program executable by a computer, the computer program controlling the computer to function as:
a first display controller configured
to display a list of first objects representing actions on a touch screen display,
to display, on the touch screen display, a list of second objects representing targets corresponding to one of the actions represented by one of the first objects when a touch operation is performed on the one first object displayed on the touch screen display, and
to display, on the touch screen display, a list of third objects representing programs for executing the one action represented by the one first object on one of the targets represented by one of the second objects when a touch operation is performed on the one second object displayed on the touch screen display; and
a second display controller configured
to display the list of the second objects representing the targets of the actions on the touch screen display,
to display, on the touch screen display, the list of the first objects representing the actions to be performed on one of the targets represented by one of the second objects when a touch operation is performed on the one second object displayed on the touch screen display, and
to display the list of the third objects representing the programs for executing one of the actions represented by one of the first objects on the one target represented by the one second object after a touch operation is performed on the one first object displayed on the touch screen display.
